(19) United States
(12) Patent Application Publication
(10) Pub. No.: US 2026/0311577 A1
(43) Pub. Date: Oct. 8, 2026

(54) PROTECTION SYSTEM FOR A STRUCTURE DISPOSED AT THE SURFACE OF A BODY OF WATER

(71) Applicant: Peter S. Maniatty, Laconia, NH (US)

(72) Inventor: Peter S. Maniatty, Laconia, NH (US)

(21) Appl. No.: 19/459,809

(22) Filed: Jan. 26, 2026

Related U.S. Application Data
(60) Provisional application No. 63/749,193, filed on Jan. 24, 2025.

(51) Int. Cl. G08B 13/16; G08B 13/196

(52) U.S. Cl. CPC G08B 13/1654; G08B 13/19647

(57) ABSTRACT

A protection system for a structure at least partially disposed in a body of water is provided that includes an environmental sensor, a communications module, a water surface disruption device, and a system controller. The environmental sensor is configured to sense an environmental value at a location of the structure. The system controller is in communication with the environmental sensor, the communications module, the water surface disruption device, and a non-transitory memory storing instructions. The instructions when executed cause the system controller to: receive and process signals from the environmental sensor; control the communications module to selectively communicate data; and control the water surface disruption device.

This application claims priority to U.S. Patent Appln. No. 63/749,193 filed Jan. 24, 2025 which is hereby incorporated herein by reference in its entirety.

### BACKGROUND OF THE INVENTION

### 1. Technical Field

The present disclosure is directed to monitoring systems in general, and to monitoring systems configured to monitor structures at a water line in particular.

### 2. Background Information

Many recreational boat owners secure their boat to a dock and/or a boathouse during the boating season. The dock may be a floating dock that is connected to fixed structures (e.g., pylons) and the boathouse may be fixed to the ground. Dock and boat security are important issues. Boats can be stolen or burglarized, or they can become untethered, or become unbuoyant. Many boat owners live a distance away from their boats and are able to inspect the boat and dock infrequently. It would be highly desirable to be able to monitor the current situation of a boat and/or a dock on a real time basis from anywhere.

### SUMMARY

According to an aspect of the present disclosure, a protection system for a structure at least partially disposed in a body of water is provided that comprises an environmental sensor, a communications module, a water surface disruption device, and a system controller. The environmental sensor is configured to sense an environmental value at a location of the structure. The system controller is in communication with the environmental sensor, the communications module, the water surface disruption device, and a non-transitory memory storing instructions. The instructions when executed cause the system controller to: receive and process signals from the environmental sensor; control the communications module to selectively communicate data; and control the water surface disruption device.

In any of the aspects or embodiments described above and herein, the environmental sensor may include a water temperature sensor that is configured to detect the environmental value, and the environmental value is a water temperature at a surface of the body of water at the location of the structure.

In any of the aspects or embodiments described above and herein, the environmental sensor may include an air temperature sensor that is configured to detect the environmental value, and the environmental value is an ambient air temperature at the location of the structure.

In any of the aspects or embodiments described above and herein, the environmental sensor may include a camera that is configured to produce an image of the structure. The camera may be a video camera.

In any of the aspects or embodiments described above and herein, the system may include a remote device module in communication with the communications modules and the remote device may be configured to receive and display information from the communications module that is representative of one or more of the water temperature at the surface of the body of water, the ambient air temperature at the location of the structure, and the image of the structure.

In any of the aspects or embodiments described above and herein, the remote device may be configured to permit an end user to control of the water surface disruption device.

In any of the aspects or embodiments described above and herein, the control of the water surface disruption device may include turning the water surface disruption device on or off.

In any of the aspects or embodiments described above and herein, the control of the water surface disruption device may include controlling the performance of the water surface disruption device when the water surface disruption device is turned on.

In any of the aspects or embodiments described above and herein, the system may comprise a system housing that encloses the communications module and the system controller, and the system housing may be configured to be located at the structure.

In any of the aspects or embodiments described above and herein, the system may comprise a system housing that encloses the communications module and the system controller, and the system housing may be configured to be located remote from the structure and the environmental sensor.

According to an aspect of the present disclosure, a protection system for structures at least partially disposed in a body of water is provided that comprises a remote server, a first protection system, and a second protection system. The first protection system is for a first structure that is at least partially disposed in a first body of water. The first protection system comprises a first environmental sensor, a first communications module, a first water surface disruption device, and a first system controller. The first environmental sensor is configured to sense a first environmental value at the first structure. The first system controller is in communication with the first environmental sensor, the first communications module, the first water surface disruption device, and a first non-transitory memory storing first instructions. The first instructions when executed cause the first system controller to receive and process first signals from the first environmental sensor, control the first communications module to selectively communicate first data, and control the first water surface disruption device. The second protection system is for a second structure that is at least partially disposed in a second body of water. The second protection system comprises a second environmental sensor, a second communications module, a second water surface disruption device, and a second system controller. The second environmental sensor is configured to sense a second environmental value at the second structure. The second system controller is in communication with the second environmental sensor, the second communications module, the second water surface disruption device, and a second non-transitory memory storing second instructions. The second instructions when executed cause the second system controller to receive and process second signals from the second environmental sensor, control the second communications module to selectively communicate second data, and control the second water surface disruption device. The remote server is in communication with the first protection system and the second protection system, and the remote server is configured to control the first protection system and the second protection system.

In any of the aspects or embodiments described above and herein, the remote server may be in communications with a website that is configured to permit a first end user to access first information pertaining to the first protection system, and to permit a second end user to access second information pertaining to the second protection system.

In any of the aspects or embodiments described above and herein, the website may be configured to permit the first end user to control the first protection system, and to permit the second end user to control the second protection system.

In any of the aspects or embodiments described above and herein, the remote server may be configured to permit an administrator to update the first protection system and the second protection system.

In any of the aspects or embodiments described above and herein, the remote server may be in communications with a smartphone application that is configured to permit a first end user to access first information pertaining to the first protection system, and to permit a second end user to access second information pertaining to the second protection system.

In any of the aspects or embodiments described above and herein, the smartphone application may be configured to permit the first end user to control the first protection system, and to permit the second end user to control the second protection system.

In any of the aspects or embodiments described above and herein, the first body of water is the same as the second body of water.

In any of the aspects or embodiments described above and herein, the first body of water is different than the second body of water.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood that the following description and drawings are intended to be exemplary in nature and non-limiting.

### BRIEF DESCRIPTION OF THE DRAWINGS

FIG. 1 is a diagrammatic view of a system housing unit.

FIG. 2 is a schematic representation of a present disclosure system embodiment.

FIG. 3 is a schematic representation of a functionality of a present disclosure system embodiment.

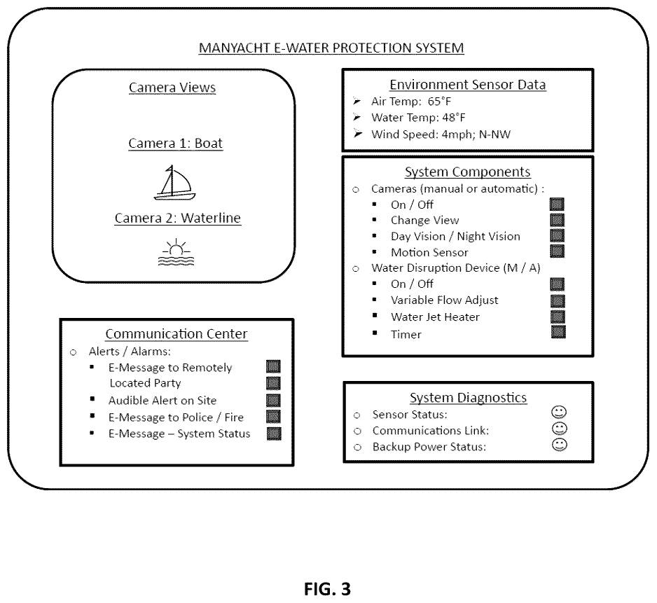

### DETAILED DESCRIPTION

The present disclosure monitoring system may be used to protect a structure and/or to control the protection of a structure that is disposed in a body of water during freezing conditions. The body of water may be freshwater or saltwater. The structure may be a dock, a boat, or any other structure exposed to the body of water. Embodiments of the present disclosure system may be configured to use communications technology to allow a user to monitor system status and environmental conditions at the site, and/or to actively engage the system to control system components that will protect the structure in or at the water site. As will be detailed herein, the communications may enable a user to communicate with the system from virtually any remote location by using communications technology; e.g., cellular communications, or satellite communications (e.g., Starlink communications), or hardwire communications (e.g., Internet connections or the like), or the like.

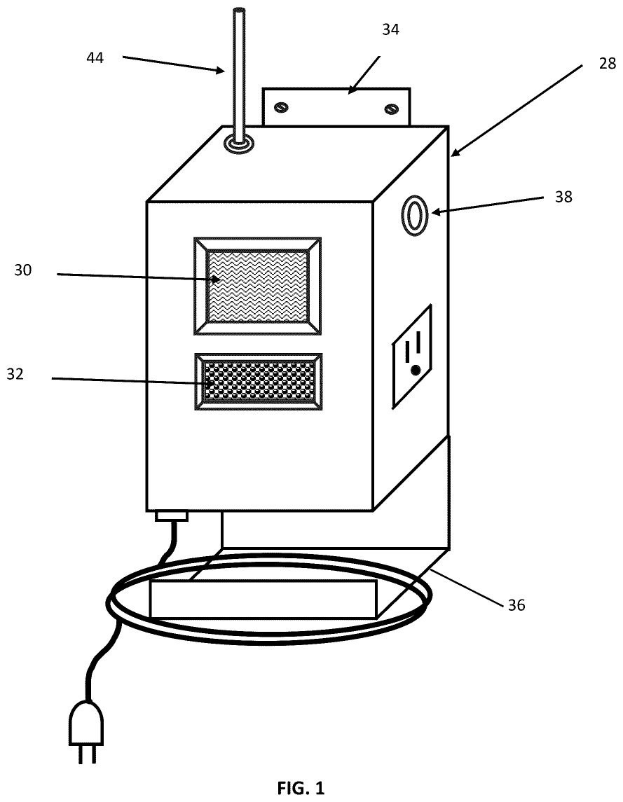

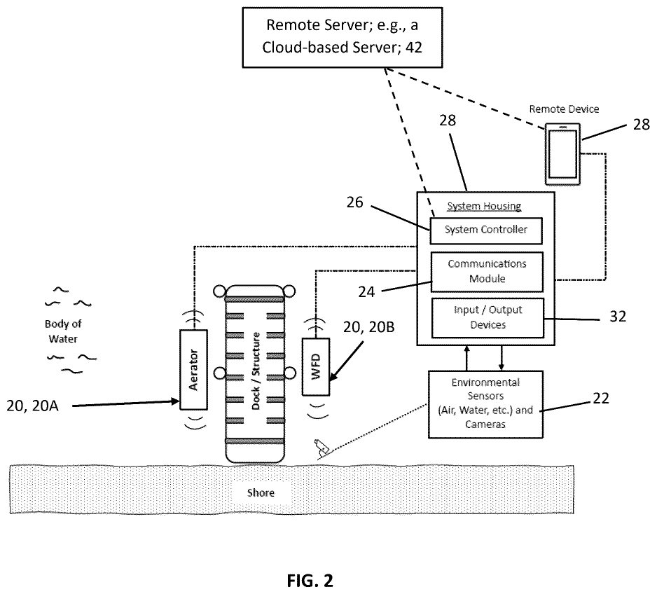

Embodiments of the present disclosure system may include some or all of the following components: a water surface disruption device 20 (e.g., a “WSD” device such as an aerator 20A, a water flow device 20B, or the like—see FIG. 2), environmental sensors 22, a communications module 24, a system controller 26, and a system housing 28. The system housing 28 is configured to contain system components. The system housing 28 embodiment shown in FIG. 1 provides external access to system components; e.g., a display screen 30, an input device 32, etc. Alternatively, the system housing 28 may be an enclosure that can be opened (e.g., via a door) to provide access to certain system components. The system housing 28 may be configured to contain system components in a weathertight manner to prevent environmental contamination (e.g., water) of the system components. The system housing 28 may be configured as a stand-alone device or may be configured for mounting on a surface. The system housing 28 example shown in FIG. 1 includes a flange 34 configured to permit the housing 28 to be mounted on a surface, and a flange 36 for storing an electrical cord in those embodiments that include an electrical cord.

In those embodiments wherein the WSD device 20 is an aerator 20A (see FIG. 2), the aerator 20A includes an air source configured to produce a stream of air beneath a water surface to produce air bubbles rising to the surface. The air source may include a fluid pump configured to draw in ambient air and convey that ambient air into a conduit that extends under the surface of the water. The aerator 20A may be configured to produce a fixed volumetric rate of air flow or it may be configured to produce air flow at a plurality of different volumetric flow rates. In some embodiments, an aerator 20A may include a selector that can be manually actuated to cause the aerator 20A to produce air flow at different volumetric rates. In some embodiments, an aerator 20A may be electronically controllable to produce air flow at different volumetric rates. An electronically controllable aerator 20A may be switched from an “off mode” wherein the pump does not produce an air flow to an “on mode” wherein the pump produces an air flow, and may be further controllable to produce air flow at different volumetric flow rates. As will be detailed herein, a system controller 26 may be used to control system components like an electronically controllable aerator 20A.

In those embodiments wherein the WSD device is a water flow device 20B (“WFD”—e.g., see FIG. 2) is configured to produce water movement around the structure to be protected. The WFD may be adjustable to tailor the amount of water movement necessary to prevent ice formation contiguous with the structure to be protected. The WFD may take several different forms. An example of an acceptable WFD is a device that produces a flow of water, such as a water jet that disrupts the water surface. In this embodiment, the WFD may be configured to draw water (e.g., pump) from some distance below the water surface which will likely be at a higher temperature than the temperature of water at the surface, and may be appreciably higher in temperature than the ambient air. The flow characteristics (flow velocity, volumetric flow rate, nozzle characteristics, pressure, etc.) of the water being used to disturb the water surface adjacent the structure can be varied to suit the application. In some embodiments, the WFD could include a water heating element that increases the temperature of the water as it passes through the WFD. Another example of an acceptable WFD is a mechanical device that disturbs the surface of the body of water. The mechanical device (e.g., a water wheel, a propeller, or the like) may be configured to produce different types of disturbances; e.g., turbulence, a directional water flow, or the like. Here again, the characteristics of the water disturbance can be varied to suit the application. These WFD examples are provided to illustrate structure that may be used in the present disclosure, and the present disclosure is not limited thereto. WFD embodiments may be controlled by a system controller 26.

The environmental sensors 22 (see FIG. 2) may include an ambient air temperature sensor and a water temperature sensor. Some systems may include additional environmental sensors 22 such as an ambient light sensor or a motion sensor. An environmental sensor 22 included in the present disclosure may be an independent component or may be incorporated into another system component. In some embodiments, the system may be configured to be disposed in close proximity to the body of water. In these embodiments, an ambient air temperature sensor may be mounted within the system housing 28, and a water temperature sensor may be disposed in the water and in wired communication with the system housing 28. In some embodiments, the system may be configured to permit certain system components (e.g., the system controller 26) to be disposed remote from the body of water and other system components may be configured to be disposed in close proximity to the water; e.g., the system controller 26 may be disposed remotely within an environmentally protected dwelling, for example, and the environmental sensors 22 disposed proximate the water body. In any embodiment wherein an environmental sensor 22 (or other system component) is located remote from the system controller 26, the aforesaid components may be in wired or wireless communication with the system controller 26.

In some embodiments, the communications module 24 may include a visual subsystem configured to provide visual imagery of the environment surrounding the system, including the water surface surrounding the structure to be protected. The visual subsystem may include, or be in communication with, one or more cameras 38. The cameras 38 may be of a type that require lighting (e.g., ambient light, or a light source) to produce images, or cameras that can produce low-light images, or cameras that can produce infra-red images, or any combination thereof. The visual subsystem may be controlled to capture images on a periodic basis, or on demand, or may provide images in real time, or any combination thereof. The images may be still images and/or video images. Portions of the visual subsystem may be disposed within a system housing 28 embodiment disposed in close proximity the body of water (e.g., FIG. 1 diagrammatically illustrates a camera 38 mounted on the housing 28), or may be disposed remotely elsewhere. In some embodiments, the cameras may have an ability to zoom in as desired.

The communications module 24 may be configured to communicate system information to the end user. The information may be produced by system environmental sensors 22 (e.g., air temperature sensors, water temperature sensors, and the like), system cameras 38, system status information (e.g., from system diagnostics), and the like. The present disclosure contemplates that the communications module 24 may communicate such information in several different ways. The communications module 24 may be configured as a “passive” device or as an “active” device, or may be controllable to selectively operate in a passive mode or in an active mode. A “passive” communications module 24 will not provide such information unless prompted. A passive communications module 24 may provide the information in response to a periodic automated request (i.e., a “prompt”) from a remote device and/or may provide the information in response to a real time end user request. Remote devices 40 for accessing a passive communications module 24 include an Internet website, or a smart phone/tablet mobile application (i.e., an “app”), a satellite phone (e.g., a phone using Starlink communications), or the like. An “active” communications module 24 may provide information (i.e., “broadcast”) automatically on a real time basis or provide information periodically. An active communications module 24 may communicate to an Internet website, or a mobile app, or a satellite phone (e.g., a phone using Starlink communications), or the like, or any combination thereof. In those embodiments wherein the communications module 24 operates in a wireless manner, the communications module 24 may be connected to a transmitting/receiving device like the antenna 44 shown in FIG. 1.

The system controller 26 is in communication with other system components such as the WSD device (e.g., aerator 20A, WFD, or the like) the environmental sensors 22, the communications module 24, and the like. The system controller 26 may be in communication with system components to control the operation of the respective component and/or to receive signals from and/or transmit signals to that component to perform the functions described herein. The system controller 26 may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system to accomplish the same algorithmically and/or coordination of system components. The system controller 26 includes, or is in communication with, one or more memory devices. The present disclosure is not limited to any particular type of memory device, and the memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information. The system controller 26 may include, or may be in communication with, an input device that enables a user to enter data and/or instructions, and may include, or be in communication with, an output device configured, for example to display information (e.g., a visual display or a printer), or to transfer data, etc. Communications between the system controller 26 and other system components may be via a hardwire connection or via a wireless connection.

In some embodiments, a system component may include a controller 26 that is in communication with the system controller 26. Some present disclosure embodiments may utilize a remote server 42. The remote server 42 (e.g., a cloud based server) may include a controller 26 that is in communication with the system controller 26 of a present disclosure monitoring system. The “controller” in these examples functions and may have the characteristics described above in the context of a system controller 26.

In some embodiments, the system may include an input device 32 configured to enable an end user to enter data and/or instructions, and/or may include an output device configured, for example, to display information (e.g., a visual display). The input device may assume a variety of different configurations. An example of an acceptable input device 32 is a key pad that allows the end user to enter information for use by the system controller 26, or a touch screen digitizer (“touch screen”), or the like. The input device 32 may be mounted so as to be accessible on an exterior surface of the system housing 28 (e.g., as shown in FIG. 1) or may be mounted on an enclosable surface of the system housing 28. The input device 32 may also be a “remote” device that is in communication with the system; e.g., see FIG. 2. For example, a remote input device (e.g., a computer with Internet communications, or a smart phone/tablet mobile application (i.e., an “app”), or a satellite phone (e.g., a phone using Starlink communications) or the like) may be configured to allow a user to input commands (e.g., on/off, increase/decrease, and the like) into the system. The remote input device may coordinate with the communications module 24 to effectuate the appropriate action. The output device may assume a variety of different configurations. An example of an acceptable output device is a display screen 30 configured to display information from the system controller 26. The output device may be mounted so as to be accessible on an exterior surface of the system housing 28 (e.g., diagrammatically shown in FIG. 1 as a display screen 30) or may be mounted on an enclosable surface of the system housing 28. In those embodiments that utilize a touch screen, the functionality of the input device 32 and the output device may be combined into a single device. In similar manner as the remote input device detailed above, the output device may also be a “remote” device that is in communication with the system. For example, a remote output device (e.g., a computer with Internet communications, or a smart phone/tablet mobile application (i.e., an “app”), a satellite phone (e.g., a phone using Starlink communications), or the like) may be configured to display information to a user. The remote output device may coordinate with the communications module 24. FIG. 1 provides a non-limiting example of a system display screen 30 that may be used in an app, or on a website, or the like. In either case, the app may have touch screen capability.

The system may include various electronic components (e.g., relays, switches, power control devices, timers, and the like) configured and arranged to carry out the functionality detailed herein.

The system embodiment diagrammatically shown in FIG. 1 includes a power cord for plugging the system into a power source; e.g., an AC power source. Alternatively, or in addition, the system may include a power storage device (e.g., a battery) configured to provide electrical power to the system, or a solar panel capable of producing electrical power for use by the system and/or for recharging a power storage device, or any combination thereof.

As stated above, embodiments of the present disclosure system may include some or all of the following components: an aerator 20A, a water disruption device (“WDD”), environmental sensors 22, a communications module 24, a system controller 26, and a housing 28. To be clear, embodiments of the present disclosure do not require all of the aforesaid components, and embodiments of the present disclosure may include various combinations of the components and possibly other components as well. The present disclosure is not limited to any particular combination of components. As an example, some embodiments of the present disclosure may include a system controller 26 alone, or a system controller 26 in combination with a communications module 24, that is/are configured to communicate with and/or control independent devices (e.g., aerators 20A, WFDs, sensors 22, and the like) according to the functionality described herein.

The present disclosure system may be configured to operate in a variety of different operational modes. For example, the system may be configured to be in a “on mode” wherein sensors 22 are continuously sensing, or the system may be configured to be in the “on mode” periodically, or portions of the system may be configured to reside in a “sleep mode” as a default configuration, and the system may transition out of the sleep mode based on sensor input or by user prompt. The system may be configured to operate based on a temporal basis; e.g., transition from an off mode to an on mode at a first daily time (e.g., in the evening), and transition from the on mode to the off mode at a second daily time (e.g., in the morning). The present disclosure system is not limited to any particular operational mode, and in some instances may operate using a plurality of different operational modes.

The present disclosure system may be configured to produce certain communications upon the occurrence of an event. For example, the system may be configured to communicate with an end user (e.g., alert the end user) in the event the ambient air temperature drops below a threshold temperature or the water temperature drops below a threshold temperature. As another example, the system may be configured to communicate with an end user in the event a diagnostic routine indicates a system fault; e.g., a system component inoperable, or power to the system is out. As yet another example, the system may be configured to communicate with an end user in the event that a motion detector detects motion proximate the structure; e.g., the dock.

In some embodiments, the present disclosure system may be configured to execute operational instructions. For example, the system may be configured to change a system component (e.g., a WSD device like an aerator 20A, or a water flow device 20B, and the like) from an off mode to an on mode upon receiving a signal from an ambient air temperature sensor indicating that the ambient air is below a threshold temperature, or upon receiving a signal from a water temperature sensor indicating that the water is below a threshold temperature. Another example of the present system executing operational instructions includes the end user inputting instructions to the system; e.g., inputting instructions via a website, or via a mobile app, of an input device 32 including with the system housing 28.

In some embodiments, the present disclosure may include an upper tier monitoring functionality that may be utilized by a service provider (e.g., a business that provides marine monitoring services) to communicate with one or more present disclosure system embodiments monitoring at an individual level, and that service provider monitors the respective individual level present disclosure systems. In this aspect of the present disclosure, the “service provider” may be an entity that monitors multiple structures to be protected; i.e., the individual level. Each individual level present disclosure system may be disposed to monitor a different structure to be protected. Each structure to be protected may be disposed at the same location (e.g., different docks at a single marina) or may be disposed at different docks at different geographic locations; e.g., a first dock at a first lake, a second dock at a second lake, and so on. In this embodiment of the present disclosure, the service provided may utilize the upper tier monitoring functionality within a remote server 42 (e.g., a cloud based server) to communicate with individual level present disclosure systems to monitor and/or control the respective individual monitoring systems. In these embodiments, the service provider may provide informational access to the owner/operator of a respective individual level present disclosure system. The informational access may be provided via a mobile app or a website. As a specific example, a service provider using this aspect of the present disclosure can allow clients to access a present disclosure system embodiment via the Internet or an App. The client may then access their personal protection system by logging into the website or App with personal information; e.g., a password. Once logged in, a protection system data page specific to the client (and the client's structure to be protected, which page may be referred to as a “client page”) is opened. The client page may provide sensor data (e.g., ambient air temperature, water temperature, a video feed, or the like, or any combination thereof) and provide status data such as whether the aerator 20A is operating, of whether the WFD is operating, or the like. The client page may allow the client to enter control commands; e.g., turn the aerator 20A on or off, turn the WFD device on or off, or adjust the performance of any of these system components. Those embodiments of the present disclosure that include a cloud based system in communication with individual present disclosure monitoring systems provides several advantages. For example, the service provider may be tasked with maintaining and updating all software packages (e.g., as the administrator), including those at the individual monitoring system level, as well as communication protocols that permit communication between the various components of the present disclosure system, thereby keeping all such items current and operational.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

What is claimed is:

1. A protection system for a structure at least partially disposed in a body of water, the system comprising:
an environmental sensor configured to sense an environmental value at a location of the structure;
a communications module;
a water surface disruption device; and
a system controller in communication with the environmental sensor, the communications module, the water surface disruption device, and a non-transitory memory storing instructions, which instructions when executed cause the system controller to:
receive and process signals from the environmental sensor;
control the communications module to selectively communicate data; and
control the water surface disruption device.

2. The protection system of claim 1, wherein the environmental sensor includes a water temperature sensor that is configured to detect the environmental value, and the environmental value is a water temperature at a surface of the body of water at the location of the structure.

3. The protection system of claim 1, wherein the environmental sensor includes an air temperature sensor that is configured to detect the environmental value, and the environmental value is an ambient air temperature at the location of the structure.

4. The protection system of claim 1, wherein the environmental sensor includes a camera that is configured to produce an image of the structure.

5. The protection system of claim 4, wherein the camera is a video camera.

6. The protection system of claim 1, wherein the environmental sensor includes a water temperature sensor that is configured to detect a water temperature at a surface of the body of water at the location of the structure, and an air temperature sensor that is configured to detect an ambient air temperature at the location of the structure, and a camera that is configured to produce an image of the structure; and
wherein the system includes a remote device module in communication with the communications module and the remote device module is configured to receive and display information from the communications module that is representative of one or more of the water temperature at the surface of the body of water, the ambient air temperature at the location of the structure, and the image of the structure.

7. The protection system of claim 1, wherein the remote device module is configured to permit an end user to control of the water surface disruption device.

8. The protection system of claim 7, wherein the control of the water surface disruption device includes turning the water surface disruption device on or off.

9. The protection system of claim 7, wherein the control of the water surface disruption device includes controlling the performance of the water surface disruption device when the water surface disruption device is turned on.

10. The protection system of claim 1, further comprising a system housing that encloses the communications module and the system controller, wherein the system housing is configured to be located at the structure.

11. The protection system of claim 1, further comprising a system housing that encloses the communications module and the system controller, wherein the system housing is configured to be located remote from the structure and the environmental sensor.

12. A protection system for structures at least partially disposed in a body of water, the system comprising:
a remote server;
a first protection system for a first structure at least partially disposed in a first body of water, wherein the first protection system comprises:
a first environmental sensor configured to sense a first environmental value at the first structure;
a first communications module;
a first water surface disruption device; and
a first system controller in communication with the first environmental sensor, the first communications module, the first water surface disruption device, and a first non-transitory memory storing first instructions, which first instructions when executed cause the first system controller to receive and process first signals from the first environmental sensor, control the first communications module to selectively communicate first data, and control the first water surface disruption device; and
a second protection system for a second structure at least partially disposed in a second body of water, wherein the second protection system comprises:
a second environmental sensor configured to sense a second environmental value at the second structure;
a second communications module;
a second water surface disruption device; and
a second system controller in communication with the second environmental sensor, the second communications module, the second water surface disruption device, and a second non-transitory memory storing second instructions, which second instructions when executed cause the second system controller to receive and process second signals from the second environmental sensor, control the second communications module to selectively communicate second data, and control the second water surface disruption device;
wherein the remote server is in communication with the first protection system and the second protection system, and the remote server is configured to control the first protection system and the second protection system.

13. The protection system of claim 12, wherein the remote server is in communications with a website that is configured to permit a first end user to access first information pertaining to the first protection system, and to permit a second end user to access second information pertaining to the second protection system.

14. The protection system of claim 13, wherein the website is configured to permit the first end user to control the first protection system, and to permit the second end user to control the second protection system.

15. The protection system of claim 13, wherein the remote server is configured to permit an administrator to update the first protection system and the second protection system.

16. The protection system of claim 12, wherein the remote server is in communications with a smartphone application that is configured to permit a first end user to access first information pertaining to the first protection system, and to permit a second end user to access second information pertaining to the second protection system.

17. The protection system of claim 16, wherein the smartphone application is configured to permit the first end user to control the first protection system, and to permit the second end user to control the second protection system.

18. The protection system of claim 12, wherein the first body of water is the same as the second body of water.

19. The protection system of claim 12, wherein the first body of water is different than the second body of water.
